(19) United States
(12) Patent Application Publication
(10) Pub. No.: US 2026/0163367 A1
(43) Pub. Date: Jun. 11, 2026

(54) MULTI-POWERED VEHICLE STARTER SYSTEM AND METHODS OF USE

(71) Applicant: IRAJ KARIMI, CARLSBAD, CA (US)

(72) Inventor: IRAJ KARIMI, CARLSBAD, CA (US)

(21) Appl. No.: 19/280,214

(22) Filed: Jul. 25, 2025

Related U.S. Application Data
(60) Provisional application No. 63/730,265, filed on Dec. 10, 2024.

(51) Int. Cl. H02J 1/10; B60R 16/03; F02N 19/00; H02J 7/34

(52) U.S. Cl. CPC H02J 1/122; H02J 7/345; B60R 16/03; F02N 19/00

(57) ABSTRACT

A battery jumpstarter system and method of use can be used to jumpstart all types of vehicles, including light duty passenger cars, trucks, commercial and construction vehicles, and even the most heavy-duty vehicles including military vehicles. Also, the jumpstarter system can include a switching power supply subsystem, a capacitor bank, a sensor, and a processor subsystem. The processor can be configured to control the sequential timing of releasing ascending or descending electrical current from the capacitor bank through control of parallel circuitry capacitors, batteries, or a combination thereof. The jumpstarter system is portable and has various configurations of the operatively coupled subsystems to yield a powerful and convenient jumpstarter system.

### PRIORITY

This application claims the benefit of the filing date of U.S. Provisional Application 63/730,265, filed Dec. 10, 2024, which is incorporated herein in its entirety.

### FIELD

The present disclosure relates to a multi-powered vehicle battery jumpstarter system with a switching power supply subsystem and methods of using such a system. More specifically, the present disclosure relates to systems, methods, and associated components for providing a vehicle battery jumpstarter system.

### BACKGROUND

Motor-driven automobiles and commercial vehicles, including light-duty and heavy equipment for construction or even military use, periodically require assistance to jumpstart a vehicle battery due to multiple variables. For example, an insufficient battery charge condition can be caused by a malfunctioning vehicle battery charging system, insufficient residual charge in the vehicle battery, extreme environmental factors such as subzero temperatures affecting battery charge state and performance, battery age and/or condition, poorly functioning battery charging systems such as alternator deficiencies, and the like. Even in view of technological advances in battery design and performance, there exists a need for an improved battery jumpstarter system that is capable of providing sufficient charge to such vehicle batteries, especially to vehicles of varying size and engine volume. As a further example, the battery jumpstarting device can be utilized in jumpstarting batteries housed in passenger automobiles of varying sizes and configurations, golf carts or utility carts, trucks, commercial vehicles and other heavy equipment, heavy duty front-loaders, bulldozers, backhoes, excavators, steamrollers, forklifts, logging equipment, boats, other specialized commercial equipment, military vehicles including tanks and other tracked vehicles, trucks, and transport vehicles, and other assorted vehicles or equipment using a starting battery that typically includes at least one battery of 12, 24 or 48 volts (nominal voltage), and also applies to battery banks including one or more of such battery types operatively connected and/or integrated into a vehicle.

Accordingly, there is a prevailing need for an improved battery jumpstarting system/device providing significant power output (i.e., high-power output), coupled with reduced weight and reduced size to replace conventional units that are inadequate and/or impractical for ever-evolving battery jumpstarting requirements.

### BRIEF SUMMARY

In an embodiment, the presently disclosed subject matter is directed to a battery jumpstarter system comprising a switching power supply subsystem comprising an inverter electrically interconnected in parallel circuitry with a capacitor bank and a battery wherein the inverter and the battery are electrically interconnected in parallel circuitry with an alternating current input source, a processor subsystem comprising at least one processor electrically interconnected in parallel circuitry with the switching power supply subsystem, wherein the processor subsystem includes a timer function and is configured to control operation of the capacitor bank, and at least one sensor electrically interconnected in parallel circuitry with the switching power supply subsystem and the processor subsystem.

In another embodiment, there is disclosed a jumpstarter system as herein disclosed further comprising a pair of charging cables to interface with a vehicle battery.

In a further embodiment, there is disclosed a jumpstarter system wherein the at least one sensor is operatively configured to provide charge status of a vehicle battery.

In yet another embodiment, there is disclosed a jumpstarter system wherein the capacitor bank is configured to provide electrical current output selected from ascending sequential electrical current, descending sequential electrical current, or equal sequential electrical current.

In still another embodiment, there is disclosed a jumpstarter system wherein the switching power supply subsystem, the capacitor bank, the processor subsystem, and the at least one sensor are combined in a single housing.

In an embodiment, there is disclosed a jumpstarter system wherein the switching power supply subsystem, the processor subsystem, the capacitor bank, and the at least one sensor are removably attached within a single housing.

In another embodiment, there is disclosed a jumpstarter system wherein the battery comprises a rechargeable battery.

In a further embodiment, there is disclosed a jumpstarter system wherein the battery comprises a Lithium-ion battery.

In yet another embodiment, there is disclosed a jumpstarter system configured to provide an initial electrical output of about 400 amps for about 5 seconds, and a subsequent sustained output of about 360 amps for about 30 seconds.

In still another embodiment, there is disclosed a jumpstarter system further comprising an accessory component comprising one or more of an inflator, a strobe light, a flashlight, a Bluetooth connection interface, and/or a digital output screen.

In an embodiment, the presently disclosed subject matter is directed to a battery jumpstarter system comprising a switching power supply subsystem comprising a first inverter electrically interconnected in parallel circuitry with a first capacitor bank; a second inverter electrically interconnected in parallel circuitry with a second capacitor bank; and a battery; wherein the first inverter, the second inverter, and the battery are electrically interconnected in parallel circuitry with an alternating current input source, a processor subsystem comprising at least one processor electrically interconnected in parallel circuitry with the switching power supply subsystem, wherein the processor subsystem includes a timer function and is configured to control operation of the first capacitor bank and the second capacitor bank; and at least one sensor electrically interconnected in parallel circuitry with the switching power supply subsystem and the processor subsystem.

In another embodiment, there is disclosed a jumpstarter system as described herein, further comprising a pair of charging cables to interface with a vehicle battery.

In yet another embodiment, there is disclosed a jumpstarter system as described herein, wherein the at least one sensor is operatively configured to provide the charge status of a vehicle battery.

In still another embodiment, there is disclosed a jumpstarter system as described herein, wherein the first capacitor bank and the second capacitor bank are configured to provide electrical current output selected from: ascending sequential electrical current; descending sequential electrical current; or equal sequential electrical current.

In a further embodiment, there is disclosed a jumpstarter system as described herein, wherein the switching power supply subsystem, the processor subsystem, the first and second capacitor banks, and the at least one sensor are combined in a single housing.

In another embodiment, there is disclosed a jumpstarter system as described herein, wherein the switching power supply subsystem, the processor subsystem, the first and second capacitor banks, and the at least one sensor are removably attached within a single housing.

In yet another embodiment, there is disclosed a jumpstarter system as described herein, wherein the battery comprises a rechargeable battery.

In still another embodiment, there is disclosed a jumpstarter system as described herein, wherein the battery comprises a Lithium-ion battery.

In a further embodiment, there is disclosed a jumpstarter system as described herein, wherein the jumpstarter system is configured to provide an initial electrical output of about 400 amps for about 5 seconds, and a subsequent sustained output of about 360 amps for about 30 seconds.

Also, in another embodiment, there is disclosed a jumpstarter system as described herein, further comprising an accessory component comprising one or more of an inflator, a strobe light, a flashlight, a Bluetooth connection interface, and/or a digital output screen.

In yet another embodiment, there is disclosed a battery jumpstarter system comprising a switching power supply subsystem comprising a first inverter electrically interconnected in parallel circuitry with a first capacitor bank, a second inverter electrically interconnected in parallel circuitry with a second capacitor bank, a third inverter electrically interconnected in parallel circuitry with a third capacitor bank, and a battery, wherein the first inverter, the second inverter, the third inverter, and the battery are electrically interconnected in parallel circuitry with an alternating current input source, a processor subsystem comprising at least one processor electrically interconnected in parallel circuitry with the switching power supply subsystem, wherein the processor subsystem includes a timer function and is configured to control operation of the first capacitor bank, the second capacitor bank, and the third capacitor bank, and at least one sensor, wherein the at least one sensor is electrically interconnected in parallel circuitry with the switching power supply subsystem and the processor subsystem.

In another embodiment, there is disclosed a jumpstarter system as described herein, further comprising a pair of charging cables to interface with a vehicle battery.

In a further embodiment, there is disclosed a jumpstarter system as described herein, wherein the at least one sensor is operatively configured to provide charge status of a vehicle battery.

In yet another embodiment, there is disclosed a jumpstarter system as described herein, wherein the first capacitor bank, the second capacitor bank, and the third capacitor bank are configured to provide electrical current output selected from ascending sequential electrical current, descending sequential electrical current, or equal sequential electrical current.

In another embodiment, there is disclosed a jumpstarter system as described herein, wherein the switching power supply subsystem, the processor subsystem, the first, second, and third capacitor banks, and the at least one sensor are combined in a single housing.

In still another embodiment, there is disclosed a jumpstarter system as described herein, wherein the switching power supply subsystem, the processor subsystem, the first, second, and third capacitor banks, and the at least one sensor are removably attached within a single housing.

In another embodiment, there is disclosed a jumpstarter system as described herein, wherein the battery comprises a rechargeable battery.

In a further embodiment, there is disclosed a jumpstarter system as described herein, wherein the battery comprises a Lithium-ion battery.

In yet another embodiment, there is disclosed a jumpstarter system as described herein, wherein the jumpstarter system is configured to provide an initial electrical output of about 600 amps for about 5 seconds, and a subsequent sustained output of about 540 amps for about 30 seconds.

In another embodiment, there is disclosed a jumpstarter system as described herein, further comprising an accessory component comprising one or more of an inflator, a strobe light, a flashlight, a Bluetooth connection interface, and/or a digital output screen.

### BRIEF DESCRIPTION OF THE SEVERAL VIEWS OF THE DRAWINGS

FIG. 1 provides an exemplary embodiment of a jumpstarter system providing an ascending sequential electrical current of the present disclosure.

FIG. 2 provides an exemplary embodiment of a jumpstarter system providing a descending sequential electrical current of the present disclosure.

FIG. 3 provides an exemplary embodiment of a jumpstarter system providing a processor subsystem and capacitor bank, along with relays, of the present disclosure.

FIG. 4 provides another exemplary embodiment of a jumpstarter system providing a processor subsystem and capacitor bank, along with transistors, of the present disclosure.

FIG. 5a provides an exemplary embodiment of a single inverter jumpstarter system of the present disclosure.

FIG. 5b provides an exemplary embodiment of a dual inverter jumpstarter system of the present disclosure.

FIG. 6a provides an exemplary embodiment of another single inverter jumpstarter system of the present disclosure.

FIG. 6b provides an exemplary embodiment of a further dual inverter jumpstarter system of the present disclosure.

FIG. 6c provides an exemplary embodiment of another dual inverter, with a first (1^{st}) capacitor bank and a second (2^{nd}) capacitor bank, in a jumpstarter system of the present disclosure.

FIG. 7 provides another exemplary embodiment of another dual inverter, with a bank of helper batteries, in a jumpstarter system of the present disclosure.

### DETAILED DESCRIPTION

For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

The following description is not an admission that any of the information provided herein is prior art or relevant to the present disclosure, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes both singular and plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute of the numeral to 10% above the absolute of the numeral, inclusive.

As used herein, the word “exemplary” means “serving as an example, instance, or illustration.” The embodiments described herein are not limiting, but rather are exemplary only. It should be understood that the described embodiments are not necessarily to be construed as preferred or advantageous over one or more other embodiments. Moreover, the terms “embodiments of the invention,” “embodiments,” “aspects,” “aspects of the invention,” or “invention” do not require that all embodiments of the invention include the discussed feature, advantage, or mode of operation.

The term “processor” as used herein encompasses, but is not limited to, processing devices, apparatuses, programs, circuits, components, systems, and subsystems, whether implemented in hardware, tangibly embodied software, or a combination of both, and whether or not it is programmable. The term “processor” as used herein also includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

A multi-powered vehicle battery jumpstarter system, with a switching power supply subsystem, as disclosed herein, can be used to start (also referred to as “boost”, “jump”, or “jumpstart”) a vehicle engine operatively coupled to an external battery. Such external battery can be a battery having nominal voltage of 12 volts or 24 volts, arranged as a single vehicle battery or battery bank (i.e., two or more operatively interconnected batteries), which can be fully or partially depleted. In one or more aspects, the battery jumpstarter system can be further configured to charge the external battery, and/or other electronic devices that are electrically and/or operatively coupled with the battery. Examples of vehicle batteries include, without limitation, lead acid batteries (e.g., wet/flooded batteries, calcium-calcium batteries, Valve-Regulated, Lead Acid (VRLA) batteries, gel cell, and Absorbed Glass Mat (AGM)) and other rechargeable batteries (e.g., batteries composed of lithium ion (Li-ion), lithium ion polymer, Nickel-Metal Hydride (NiMH), Nickel Cadmium (NiCd), and the like). Other electronic devices that can also or alternatively be operatively coupled with the battery jumpstarter system include, for example and without limitation, portable electronic devices such as cellphones, tablet computers, portable computers, and the like), as well as electronic toys, and other related battery-powered devices/systems.

Where the term “battery” is indicated, the term includes rechargeable or disposable batteries, unless expressly provided otherwise, and voltage values provided for such “battery” include nominal voltages and is not limited to absolute voltage units. The term can also include, where indicated, a plurality of electrically coupled batteries that can be, for example, connected in parallel circuitry. Coupled batteries can also be referred to as a “battery bank.”

Where a “unit”, “subunit”, “system”, or “subsystem” is indicated, associated components include one or more of a bus, processor/microprocessor, necessary interconnected circuitry, and the like, even where such supporting components are not expressly indicated, as one of ordinary skill in the art would readily understand.

As described herein, a multi-powered vehicle battery jumpstarter system can also be used to start (also referred to as “boost”, “jump”, or “jumpstart”) a plurality of vehicle engines operatively coupled to one or more external batteries. Thus, the multi-powered vehicle battery jumpstarter system described herein is also configured for ease of operatively connecting to several vehicles sequentially, and use of the multi-powered vehicle battery jumpstarter system can provide sufficient power to jumpstart several vehicles sequentially without significant drop in performance or power output from the battery jumpstarter system.

One (or more) internal battery(ies) can be a rechargeable lithium battery configured to output a direct current (DC) voltage. Example lithium batteries include, but are not limited to, lithium iron phosphate (LiFePO₄), lithium polymer (Li-poly), lithium-cobalt oxide (LiCoO₂), lithium-titanate, lithium-nickel manganese cobalt oxide (LiNiMnCoO₂ or NMC), lithium iron magnesium phosphate (LiFeMgPO₄), lithium-manganese oxide (LiMnO₂), lithium ion manganese oxide (LiMn₂O₄, Li₂MnO₃, or LMO), and the like. Also, the internal battery is not limited to a single battery or single battery cell. For example, lithium iron phosphate batteries typically provide a nominal cell voltage of about 3.2V to 3.3V each, while lithium-titanate batteries typically have a nominal cell voltage of about 2.4 V. Accordingly, multiple lithium cells can be electrically interconnected in series to achieve a desired nominal voltage for the internal battery. For example, where the nominal cell voltage is 3.2V to 3.3V, four cells can be connected to achieve a nominal voltage 12.8V to 13.2V for the internal battery. More cells can be connected, including in a series and/or parallel circuitry configuration, depending on the desired voltage.

Additional lithium cells can also, for example, be connected in series to achieve a higher nominal voltage where desired. The nominal voltage of the internal battery can be selected as a function of the nominal voltage of the external battery. In certain embodiments, the nominal voltage of the internal battery can be matched to (e.g., about the same as) the nominal voltage of the intended external battery. For example, if the nominal voltage of the intended external battery is 12 volts, then the nominal voltage of the internal battery can also be configured to about 12 volts. In another example, the internal battery can comprise four battery cells connected in series, each having a nominal cell voltage of about 3.2V to 3.3V (thus totaling 12.8V to 13.2V).

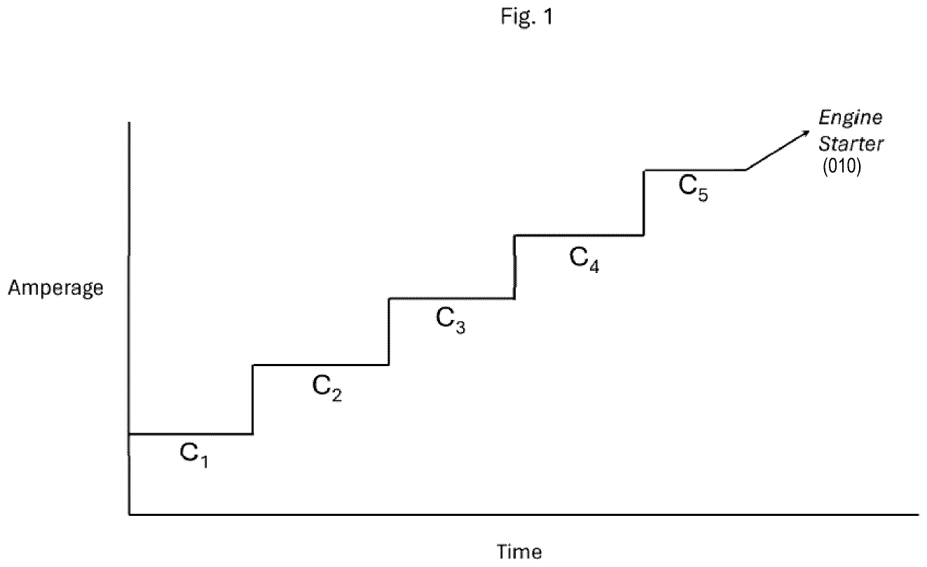

FIG. 1 provides an exemplary embodiment of a jumpstarter system providing an ascending sequential electrical current of the present disclosure. In this example of FIG. 1, there is a shorthand designation of the capacitor bank for each exemplified capacitor as “C”, with an accompanying numeric designator for each capacitor. For example, C₁ corresponds to capacitor 1, C₂ corresponds to capacitor 2, C₃ corresponds to capacitor 3, C₄ corresponds to capacitor 4, and C₅ corresponds to capacitor 5.

The chart in FIG. 1 provides a plot of electrical power (Amperage) on the Y axis, and Time on the X axis. This chart also can be referred to as a plot of ascending sequential electrical current. In operation of one or more exemplary embodiments, electrical power provided by the switching power supply subsystem is controlled by the processor subsystem, so that progressively increasing stepwise electrical current from the capacitor bank is sequentially released from the individual capacitors at a timed interval, so that (in this example) progressively increasing power is provided to jumpstart a vehicle battery. In this example, initial current is progressively increased at regular timed intervals as determined by the programmed processor of the processor subsystem. Example initial current released from C₁ can range from about 100 to 500 amps, and final current released from C₅ can range from about 100 to 500 amps. Current output to engine starter (010) is also illustrated. This ascending sequential electrical current exemplary embodiment is an example of a jumpstarting power management system to jumpstart a typical 12-volt automobile battery, such as (for example) a light duty passenger car, a sport utility vehicle, up to and including various larger passenger vehicles and light duty trucks. This ascending sequential electrical current exemplary embodiment can also be used with smaller battery powered vehicles such as golf carts, sport all-terrain vehicles, light duty boats and jet skis, other watercraft, and the like. The ascending sequential electrical current embodiment also provides a safety feature by progressively increasing the power output (i.e., to engine starter 010) without causing excessive current to potentially damage the target battery. While this example describes an embodiment including capacitors C₁ to C₅, the number of capacitors can be increased or decreased in the capacitor bank, for example, C₁ to C₂, C₁ to C₃, C₁ to C₄, C₁ to C₆, and the like, so that the initial and final power output from the capacitor bank ranges from about 100 to 500 amps. For example, a plurality of capacitors can be coupled in parallel to aggregate the individual capacitors'capacitances.

In another embodiment of FIG. 1, individual helper batteries (e.g., B₁ to B₅) can also be incorporated into the capacitor bank instead of, or in addition to, individual capacitors as described herein. In operation of this exemplary embodiment, electrical power provided by the switching power supply subsystem is controlled by the processor subsystem, so that progressively increasing stepwise electrical current from the capacitor bank is sequentially released from the individual helper batteries at a timed interval, so that (in this example) progressively increasing power is provided to jumpstart a vehicle battery. In this example, initial current is progressively increased at regular timed intervals as determined by the programmed processor of the processor subsystem. Example initial current released from a first helper battery (B₁) can range from about 100 to 500 amps, and final current released from B₅ can range from about 100 to 500 amps. This ascending sequential electrical current exemplary embodiment is an example of a jumpstarting power management to jumpstart a typical 12-volt automobile battery, such as (for example) a light duty passenger car, a sport utility vehicle, up to and including various larger passenger vehicles and light duty trucks. This ascending sequential electrical current exemplary embodiment can also be used with smaller battery powered vehicles such as golf carts, sport all-terrain vehicles, light duty boats and jet skis, other watercraft, and the like. The ascending sequential electrical current embodiment also provides a safety feature by progressively increasing the power output without causing excessive current to damage the target battery. While this example describes an embodiment including helper batteries B₁ to B₅, the number of helper batteries can be increased or decreased in the charge storage subsystem, for example, B₁ to B₂, B₁ to B₃, B₁ to B₄, B₁ to B₆, and the like, so that the initial and final power output from the capacitor bank ranges from about 100 to 500 amps. Current output to engine starter (010 is also illustrated.

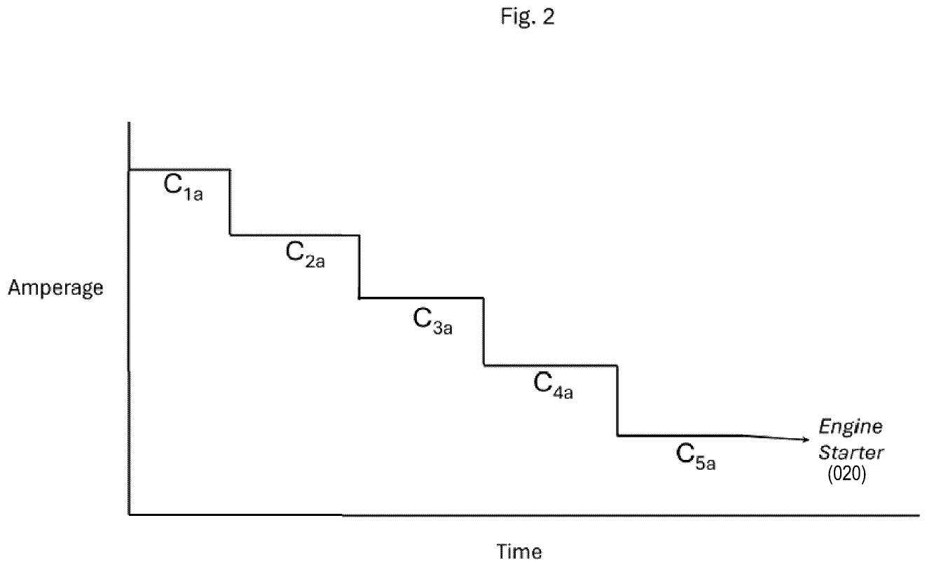

FIG. 2 shows another exemplary embodiment of the present disclosure. In this example of FIG. 2, there is a shorthand designation of the capacitor bank for each exemplified capacitor as “C”, with an accompanying numeric designator for each capacitor. For example, C₁ₐ corresponds to capacitor 1a, C₂ₐ corresponds to capacitor 2a, C₃ₐ corresponds to capacitor 3a, C₄ₐ corresponds to capacitor 4a, and C₅ₐ corresponds to capacitor 5a.

The chart in FIG. 2 provides a plot of electrical power (Amperage) on the Y axis, and Time on the X axis. This chart also can be referred to as a plot of descending sequential electrical current. In operation of one or more exemplary embodiments, electrical power provided by the switching power supply subsystem is controlled by the processor subsystem, so that progressively decreasing stepwise electrical current from the capacitor bank is sequentially released from the individual capacitors at a timed interval, so that (in this example) progressively decreasing power is provided to jumpstart a vehicle battery. Current output to engine starter (020) is also illustrated. In this example, initial current is progressively decreased at regular timed intervals as determined by the programmed processor of the switching subsystem. Example initial current released from C₁ₐ can range from about 100 to 1500 amps, and final current released from C₅ₐ can range from about 100 to 1500 amps. This descending sequential electrical current exemplary embodiment is an example of a jumpstarting power management system to jumpstart a typical 12-volt or 24-volt diesel automobile battery, such as (for example) a light duty passenger car, a sport utility vehicle, up to and including various larger passenger vehicles and light duty trucks with a diesel engine. This descending sequential electrical current exemplary embodiment can also be used with other battery powered vehicles such as large sport all-terrain vehicles, boats, other watercraft, and the like. The descending sequential electrical current embodiment also provides a safety feature by progressively decreasing the power output (i.e., to engine starter 020) without causing excessive current to potentially damage the target battery. While this example describes an embodiment including capacitors C₁ₐ to C₅ₐ, the number of capacitors can be increased or decreased in the capacitor bank, for example, C₁ₐ to C₂ₐ, C₁ₐ to C₃ₐ, C₁ₐ to C₄ₐ, C₁ₐ to C₆ₐ, and the like, so that the initial and final power output from the capacitor bank ranges from about 100 to 500 amps.

Also, heavy-duty vehicles such as commercial trucks, farm equipment including tractors and combines, construction vehicles such as steamrollers and front-end loaders, firetrucks, ambulances, and hook-and-ladder vehicles, military vehicles such as tanks, track vehicles, and salvage trucks, and the like typically have very high power needs and associated high-powered batteries that can range from about 12 to 24 volts, or even configurations of multiple batteries in such vehicles. Typically, these types of exemplified vehicles can be diesel-powered, with an associated need for an initial high-power jumpstart capability of the present system.

In another embodiment of FIG. 2, individual helper batteries (e.g., B₁ to B₅) can also be incorporated into the capacitor bank instead of, or in addition to, individual capacitors as described herein. In operation of this exemplary embodiment, electrical power provided by the switching power supply subsystem is controlled by the processor subsystem, so that progressively decreasing stepwise electrical current from the capacitor bank is sequentially released from the individual helper batteries at a timed interval, so that (in this example) progressively decreasing power is provided to jumpstart a vehicle battery. In this example, initial current is progressively decreased at regular timed intervals as determined by the programmed processor of the processor subsystem. Example initial current released from a first helper battery (B₁) can range from about 100 to 500 amps and final current released from B₅ can range from about 100 to 500 amps This descending sequential electrical current exemplary embodiment is an example of a jumpstarting power management to jumpstart a typical 12-volt or 24-volt diesel automobile battery, such as (for example) a light duty passenger car, a sport utility vehicle, up to and including various larger passenger vehicles and light duty trucks with a diesel engine. This descending sequential electrical current exemplary embodiment can also be used with other battery powered vehicles such as large sport all-terrain vehicles, boats, other watercraft, and the like. The descending sequential electrical current embodiment also provides a safety feature by progressively decreasing the power output without causing excessive current to potentially damage the target battery. While this example describes an embodiment including helper batteries B₁ to B₅, the number of helper batteries can be increased or decreased in the capacitor bank, for example, B₁ to B₂, B₁ to B₃, B₁ to B₄, B₁ to B₆, and the like, so that the initial and final power output from the capacitor bank ranges from about 100 to 500 amps.

Also, heavy-duty vehicles such as commercial trucks, farm equipment including tractors and combines, construction vehicles such as steamrollers and front-end loaders, firetrucks, ambulances, and hook-and-ladder vehicles, military vehicles such as tanks, track vehicles, and salvage trucks, and the like typically have very high power needs and associated high-powered batteries that can range from about 12 to 24 volts, or even configurations of multiple batteries in such vehicles. Typically, these types of exemplified vehicles can be diesel-powered, with an associated need for an initial high-power jumpstart capability of the present system.

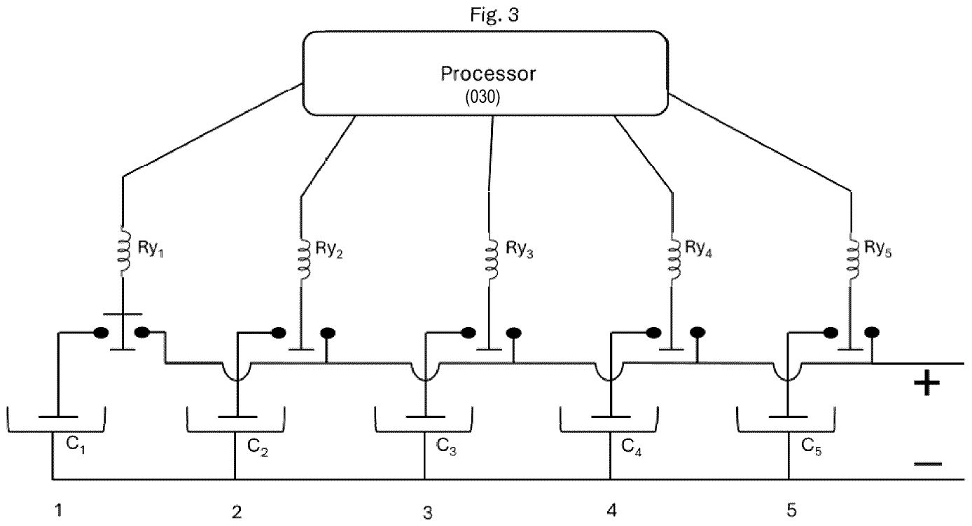

FIG. 3 shows a further exemplary embodiment of the present disclosure. In this example of FIG. 3, there is a shorthand designation for each exemplified relay as “Ry”, with an accompanying numeric designator for each relay. For example, Ry₁ corresponds to relay 1, Ry₂ corresponds to relay 2, Ry₃ corresponds to relay 3, Ry₄ corresponds to relay 4, and Ry₅ corresponds to Relay 5. While this example describes an embodiment including relays Ry₁ to Ry₅, the number of relays can be increased or decreased, for example, Ry₁ to Ry₂, Ry₁ to Ry₃, Ry₁ to Ry₄, Ry₁ to Ry₆, and the like. In an embodiment, one or more of relays Ry₁ to Ry₆ and the like can be controlled by processor (030).

Also shown in this example of FIG. 3, there is a shorthand designation for each exemplified capacitor as “C”, with an accompanying numeric designator for each capacitor. For example, C₁ corresponds to capacitor 1, C₂ corresponds to capacitor 2, C₃ corresponds to capacitor 3, C₄ corresponds to capacitor 4, and C₅ corresponds to capacitor 5. While this example of FIG. 3 describes an embodiment including capacitors C₁ to C₅, the number of capacitors can be increased or decreased in the charge storage subsystem, for example, C₁ to C₂, C₁ to C₃, C₁ to C₄, C₁ to C₆, and the like, so that the initial and final power output from the capacitor bank ranges from about 100 to more than 500 amps (i.e., >500 amps). For example, a plurality of capacitors can be coupled in parallel circuitry to aggregate the individual capacitances of the capacitors as controlled, for example, by the processor (030). In the embodiment exemplified in FIG. 3, the components are shown in one example arrangement, but other configurations of the individual components and their electrical interconnections can be varied without detracting from the system's capabilities.

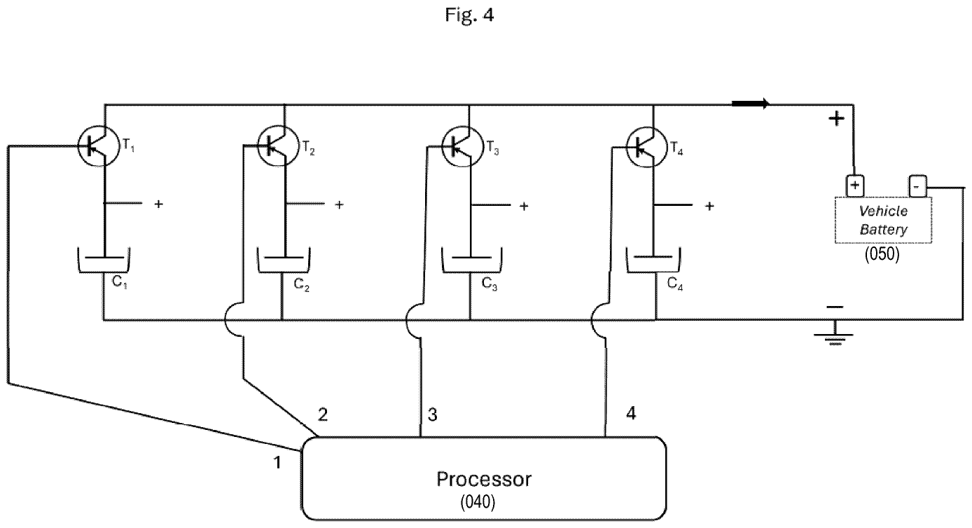

FIG. 4 shows a further exemplary embodiment of the present disclosure. In this example of FIG. 4, there is a shorthand designation for each exemplified resistor as “R”, with an accompanying numeric designator for each resistor. For example, R₁ corresponds to resistor 1, R₂ corresponds to resistor 2, R₃ corresponds to resistor 3, and R₄ corresponds to resistor 4. While this example of FIG. 4 describes an embodiment including resistors R₁ to R₄, the number of resistors can be increased or decreased, for example, R₁ to R₂, R₁ to R₃, R₁ to R₄, R₁ to R₆, and the like. In an embodiment, one or more of resistors R₁ to R₆ and the like can be controlled by processor (040).

Also shown in this example of FIG. 4, there is a shorthand designation for each exemplified Transistor as “T”, with an accompanying numeric designator for each resistor. For example, T₁ corresponds to transistor 1, T₂ corresponds to transistor 2, T₃ corresponds to transistor 3, and T₄ corresponds to transistor 4. While this example of FIG. 4 describes an embodiment including transistors T₁ to T₄, the number of transistors can be increased or decreased, for example, T₁ to T₂, T₁ to T₃, T₁ to T₄, T₁ to T₅, T₁ to T₆, and the like. Also, thristors are included in the term Transistor and can be used instead of, or in addition to, one or more transistors. In an embodiment, one or more of transistors T₁ to T₆ and the like can also be controlled by processor (040). Vehicle battery (050) is also exemplified in FIG. 4.

Further shown in FIG. 4, there is a shorthand designation for each exemplified capacitor as “C”, with an accompanying numeric designator for each capacitor. For example, C₁ corresponds to capacitor 1, C₂ corresponds to capacitor 2, C₃ corresponds to capacitor 3, and C₄ corresponds to capacitor 4. While this example of FIG. 4 describes an embodiment including capacitors C₁ to C₄, the number of capacitors can be increased or decreased in the charge storage subsystem, for example, C₁ to C₂, C₁ to C₃, C₁ to C₄, C₁ to C₆, C₁ to C₆, and the like, so that the initial and final power output from the charge storage subsystem ranges from about 100 to 1500 amps. For example, a plurality of capacitors can be coupled in parallel to aggregate the individual capacitors'capacitances. In an embodiment, one or more of capacitors C₁ to C₆ and the like can also be controlled by processor (040). In the embodiment exemplified in FIG. 4, the components are shown in one example arrangement, but other configurations of the individual components and their electrical interconnections can be varied without detracting from the system's capabilities.

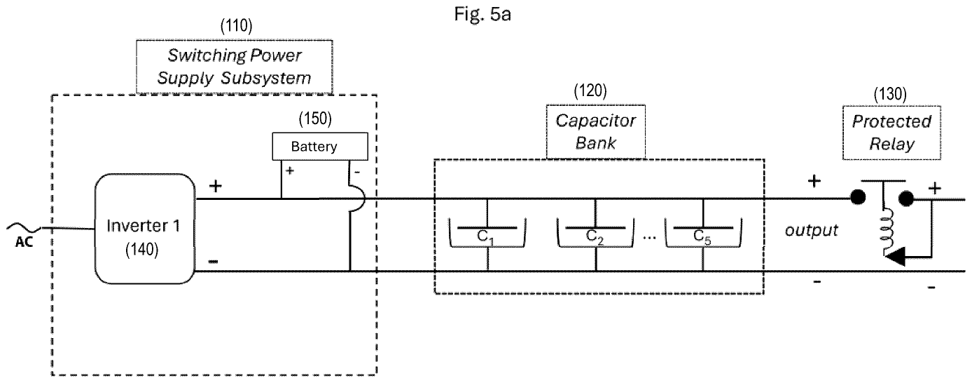

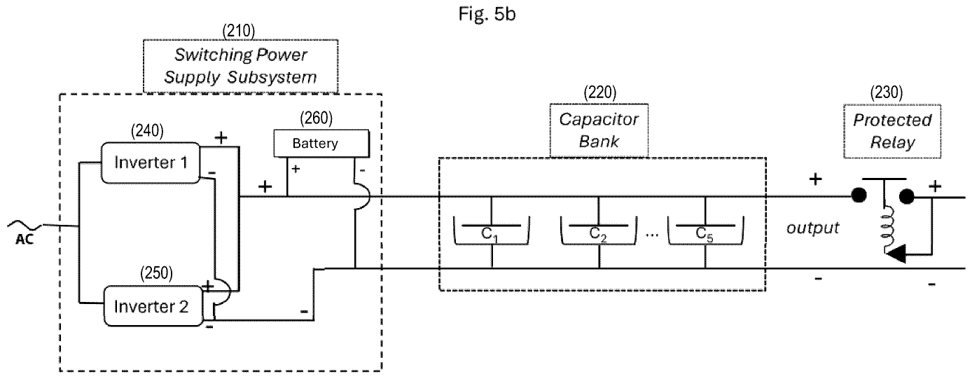

FIG. 5a shows another single inverter exemplary embodiment of the present disclosure. FIG. 5a also shows: a switching power supply subsystem (110) comprising an inverter 1 (140 ) and a battery (150); and an associated protected relay (130). In this example of FIG. 5a, there is a shorthand designation for each exemplified capacitor as “C”, with an accompanying numeric designator for each capacitor. For example, C₁ corresponds to capacitor 1, C₂ corresponds to capacitor 2, and C₅ corresponds to capacitor 5. The ellipsis ( . . . ) in FIG. 5a indicates that the example of FIG. 5a can also include additional capacitors (e.g., C₃ and C₄), but these are not shown for convenience of the FIG. 5a size in this disclosure. Note that a greater or lesser number of capacitors can be used in one or more embodiments, depending on the specific power needs for jumpstarting a vehicle battery. In an embodiment, one or more of capacitors C₁ to C₆ and the like can also be organized into a capacitor bank (120). In the embodiment exemplified in FIG. 5a, the components and subsystems are shown in one example arrangement, but other configurations of the individual components and subsystems and their electrical interconnections can be varied without detracting from the system's capabilities.

FIG. 5b shows another dual (or first and second) inverter exemplary embodiment of the present disclosure. FIG. 5b also shows: a switching power supply subsystem (210) comprising an inverter 1 (240 ), an inverter 2 (250) and a battery (260). FIG. 5b further shows an associated protected relay (130). A first inverter is exemplified as inverter 1 (240) and a second inverter is exemplified as inverter 2 (250). In this example of FIG. 5b, there is a shorthand designation for each exemplified capacitor as “C”, with an accompanying numeric designator for each capacitor. For example, C₁ corresponds to capacitor 1, C₂ corresponds to capacitor 2, and C₅ corresponds to capacitor 5. The ellipsis ( . . . ) in FIG. 5b indicates that the example of FIG. 5b can also include additional capacitors (e.g., C₃ and C₄), but these are not shown for convenience of the FIG. 5b size in this disclosure. Note that a greater or lesser number of capacitors can be used in one or more embodiments, depending on the specific power needs for jumpstarting a vehicle battery. In an embodiment, one or more of capacitors C₁ to C₆ can be organized into a capacitor bank (220). In the embodiment exemplified in FIG. 5b, the components and subsystems are shown in one example arrangement, but other configurations of the individual components and subsystems and their electrical interconnections can be varied without detracting from the system's capabilities.

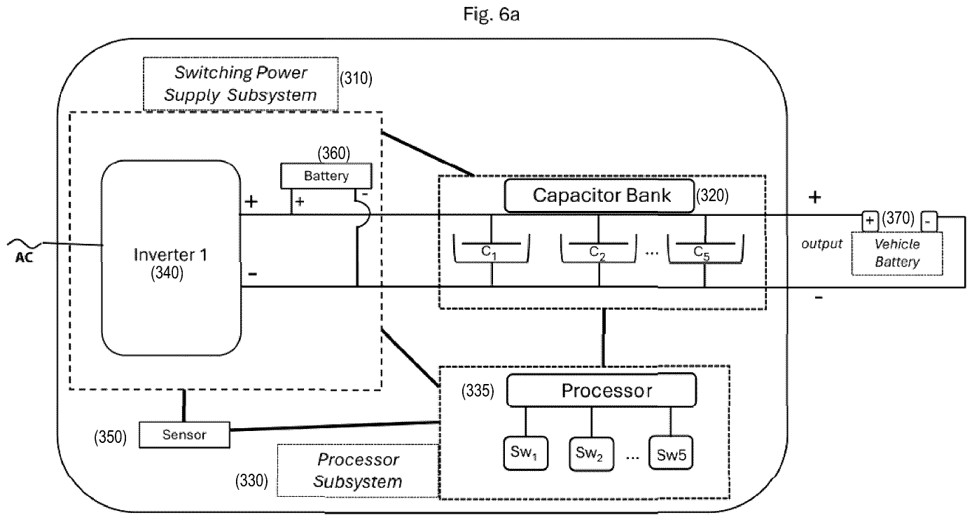

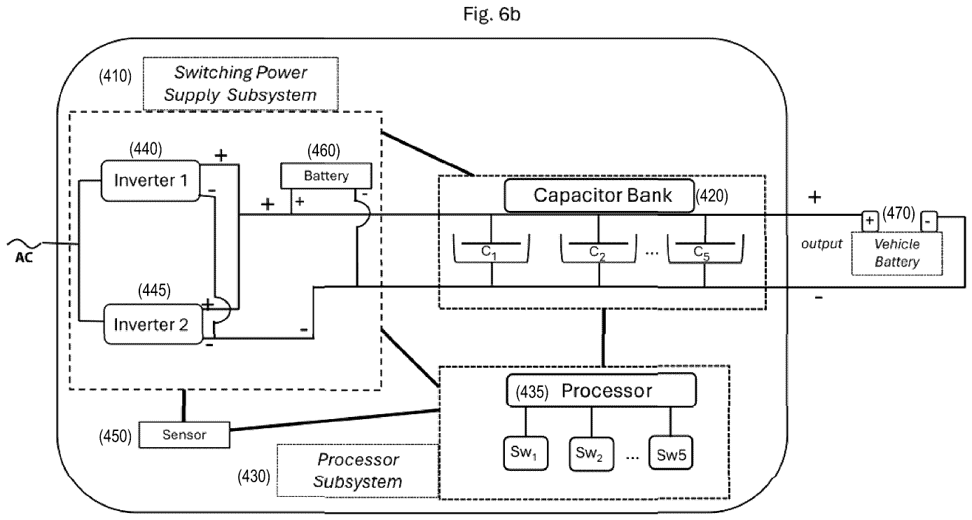

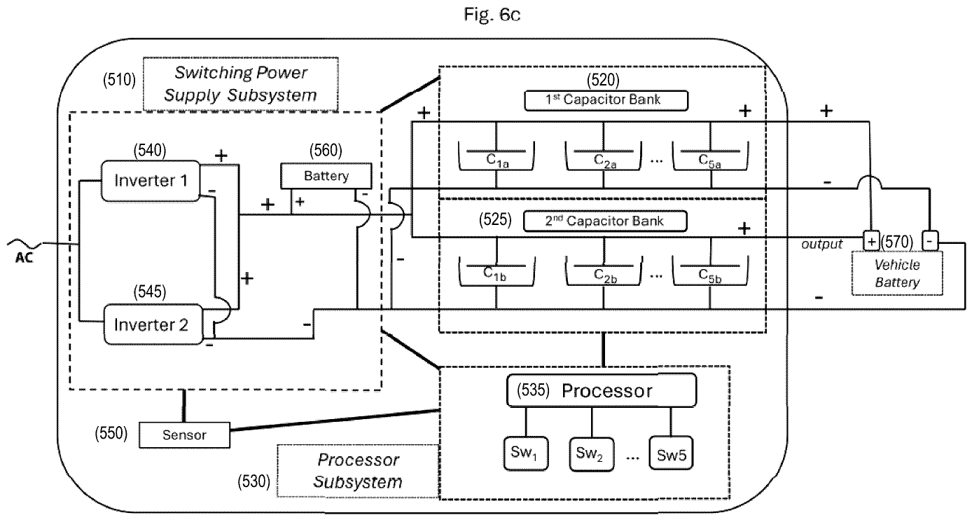

FIG. 6a shows another exemplary embodiment of the present disclosure. FIG. 6a also shows a switching power supply subsystem (310) comprising an inverter 1 (340 ) and a battery (360). In this example of FIG. 6a, there is a shorthand designation for each exemplified capacitor as “C”, with an accompanying numeric designator for each capacitor. For example, C₁ corresponds to capacitor 1, C₂ corresponds to capacitor 2, and C₅ corresponds to capacitor 5. The ellipsis ( . . . ) in FIG. 6 indicates that the example of FIG. 6a can also include additional capacitors (e.g., C₃ and C₄), but these are not shown for convenience of the FIG. 6a size in this disclosure. Note that a number of more or less capacitors can be used in a similar embodiment, depending on the specific power needs for jumpstarting a vehicle battery. Additional or fewer capacitors in one or more embodiments can be designated as “Cₓ” in which “X” is the specifically enumerated capacitor.

Also shown in this example of FIG. 6a, there is a shorthand designation for each exemplified switch component as “Sw”, with an accompanying numeric designator for each switch. For example, Sw₁ corresponds to switch 1, Sw₂ corresponds to switch 2, and Sw₅ corresponds to switch 5. The ellipsis ( . . . ) in FIG. 6a indicates that the example of FIG. 6a can also include additional switches (e.g., Sw₃ and Sw₄), but these are not shown for convenience of the FIG. 6a size in this disclosure. Note that a greater or lesser number of switches can be used in one or more similar embodiments, depending on the specific power switching needs for jumpstarting a vehicle battery.

Further, FIG. 6a shows another exemplary embodiment of the present disclosure. In this example of FIG. 6a, there is an indication of a switching power supply subsystem (310), a capacitor bank (320), a sensor (350), a processor subsystem (330), a processor (335), and a vehicle battery (370). These subsystems (vehicle battery (370) can optionally be included) can all be contained in a single housing unit or container, such as a rigid plastic box or other appropriate container. Also, these subsystems can all be modular assemblies that can be individually or collectively removed or replaced into or out of a housing unit or container. Materials for such a box or container include plastics of varying densities and thicknesses, lightweight aluminum or other metal, and other synthetic materials that can be insulated or non-insulated. In one or more embodiments, the box or container can comprise a suitcase-like configuration that is portable, and can additionally have wheels for ease of portability. The container or box can be configured to weigh no more than about 75 pounds, but can also be configured to weigh 15 lbs, 20 lbs, 25 lbs, 30 lbs, 35 lbs, 40 lbs, 45 lbs, 50 lbs, 55 lbs, 60 lbs, 65 lbs, or the like, depending upon the desired power capabilities and accompanying components in the subsystems and overall jumpstarter system as described herein. In another embodiment, the subsystems can also be configured in a permanent or temporary attachment to a base, so that one or more of the subsystems can be added or removed as necessary. In another embodiment, one or more of the subsystems can be fully or partially contained within, on, or adjacent to the housing container for ease of portability prior to, or during operation of, the jumpstarter system. In another embodiment, one or more associated components can be added or removed from the system as appropriate, such as individual jumper cables, alarms, other sensors and electrical interconnections for operation of the jumpstarter system. In the embodiment exemplified in FIG. 6b, the components and subsystems are shown in one example arrangement, but other configurations of the individual components and subsystems and their electrical interconnections can be varied without detracting from the system's capabilities.

FIG. 6b shows another exemplary embodiment of the present disclosure. In this example of FIG. 6b, there is a shorthand designation for each exemplified switch component as “Sw”, with an accompanying numeric designator for each switch. For example, Sw₁ corresponds to switch 1, Sw₂ corresponds to switch 2, and Sw₅ corresponds to switch 5. The ellipsis ( . . . ) in FIG. 6b indicates that the example of FIG. 6b can also include additional switches (e.g., Sw₃ and Sw₄), but these are not shown for convenience of the FIG. 6b size in this disclosure. Note that a greater or lesser number of switches can be used in one or more similar embodiments, depending on the specific power switching needs for jumpstarting a vehicle battery.

Further, FIG. 6b shows another exemplary embodiment of the present disclosure. In this example of FIG. 6b, there is an indication of a switching power supply subsystem (410), a capacitor bank (420), a sensor (450), and a processor subsystem (430). These subsystems can all be contained in a single housing unit or container, such as a rigid plastic box or other appropriate container. Materials for such a box or container include plastics of varying densities and thicknesses, lightweight aluminum or other metal, and other synthetic materials that can be insulated or non-insulated. In one or more embodiments, the box or container can comprise a suitcase-like configuration that is portable, and can additionally have wheels for ease of portability. The container or box can be configured to weigh no more than about 75 pounds, but can also be configured to weigh 15 lbs, 20 lbs, 25 lbs, 30 lbs, 35 lbs, 40 lbs, 45 lbs, 50 lbs, 55 lbs, 60 lbs, 65 lbs, or the like, depending upon the desired power capabilities and accompanying components in the subsystems and overall jumpstarter system as described herein. In another embodiment, the subsystems can also be configured in a permanent or temporary attachment to a base, so that one or more of the subsystems can be added or removed as necessary. In another embodiment, one or more of the subsystems can be fully or partially contained within, on, or adjacent to the housing container for ease of portability prior to, or during operation of, the jumpstarter system. In another embodiment, one or more associated components can be added or removed from the system as appropriate, such as individual jumper cables, alarms, other sensors and electrical interconnections for operation of the jumpstarter system. In the embodiment exemplified in FIG. 6b, the subsystems are shown in one example arrangement, but other configurations of the individual subsystems and their electrical interconnections can be varied without detracting from the system's capabilities.

Also, FIG. 6b shows another exemplary embodiment of the present disclosure. In this example of FIG. 6b, there is an indication of a capacitor bank (420) electrically interconnected in parallel circuitry with inverter 1 (440) and inverter 2 (445) of the switching power supply subsystem (410). The capacitor bank (420) is also electrically interconnected in parallel circuitry with the processor subsystem (430) and the sensor (450). The switching power supply subsystem (410), the capacitor bank (420), the processor subsystem (430), and the sensor (450) are all electrically interconnected in parallel circuitry. The sensor (450) can include 1 or more sensors, and the capacitor bank (420) can include 1 or more bank(s) of capacitors. A vehicle battery (470) is also shown in FIG. 6b.

FIG. 6c shows another exemplary embodiment of the present disclosure. In this example of FIG. 6c, there is a shorthand designation for each exemplified switch component as “Sw”, with an accompanying numeric designator for each switch. For example, Sw₁ corresponds to switch 1, Sw₂ corresponds to switch 2, and Sw₅ corresponds to switch 5. The ellipsis ( . . . ) in FIG. 6a indicates that the example of FIG. 6a can also include additional switches (e.g., Sw₃ and Sw₄), but these are not shown for convenience of the FIG. 6c size in this disclosure. Note that a greater or lesser number of switches can be used in one or more similar embodiments, depending on the specific power switching needs for jumpstarting a vehicle battery.

Further, FIG. 6c shows another exemplary embodiment of the present disclosure. In this example of FIG. 6c, there is an indication of a switching power supply subsystem (510), a 1^{st} capacitor bank (520), a 2^{nd} capacitor bank (525), a sensor (550), and a processor subsystem (530). A processor (535) and a vehicle battery (570) are also shown. These subsystems can all be contained in a single housing unit or container, such as a rigid plastic box or other appropriate container. Materials for such a box or container include plastics of varying densities and thicknesses, lightweight aluminum or other metal, and other synthetic materials that can be insulated or non-insulated. In one or more embodiments, the box or container can comprise a suitcase-like configuration that is portable, and can additionally have wheels for ease of portability. The container or box can be configured to weigh no more than about 75 pounds, but can also be configured to weigh 15 lbs, 20 lbs, 25 lbs, 30 lbs, 35 lbs, 40 lbs, 45 lbs, 50 lbs, 55 lbs, 60 lbs, 65 lbs, or the like, depending upon the desired power capabilities and accompanying components in the subsystems and overall jumpstarter system as described herein. In another embodiment, the subsystems can also be configured in a permanent or temporary attachment to a base, so that one or more of the subsystems can be added or removed as necessary. In another embodiment, one or more of the subsystems can be fully or partially contained within, on, or adjacent to the housing container for ease of portability prior to, or during operation of, the jumpstarter system. In another embodiment, one or more associated components can be added or removed from the system as appropriate, such as individual jumper cables, alarms, other sensors and electrical interconnections for operation of the jumpstarter system. In the embodiment exemplified in FIG. 6c, the components and subsystems are shown in one example arrangement, but other configurations of the individual components and subsystems and their electrical interconnections can be varied without detracting from the system's capabilities.

Also, FIG. 6c shows another exemplary embodiment of the present disclosure. In this example of FIG. 6c, there is an indication of a 1^{st} capacitor bank (520) and 2^{nd} capacitor bank (525) electrically interconnected in parallel circuitry with inverter 1 (540) and inverter 2 (545) of the switching power supply subsystem (510). The 1^{st} capacitor bank (520) and 2^{nd} capacitor bank (525) are also electrically interconnected in parallel circuitry with the processor subsystem (530) and the sensor (550). The switching power supply subsystem (510), the 1^{st} capacitor bank (520) and 2^{nd} capacitor bank (525), the processor subsystem (530), and the sensor (550) are all electrically interconnected in parallel circuitry. The sensor (550) can include 1 or more sensors.

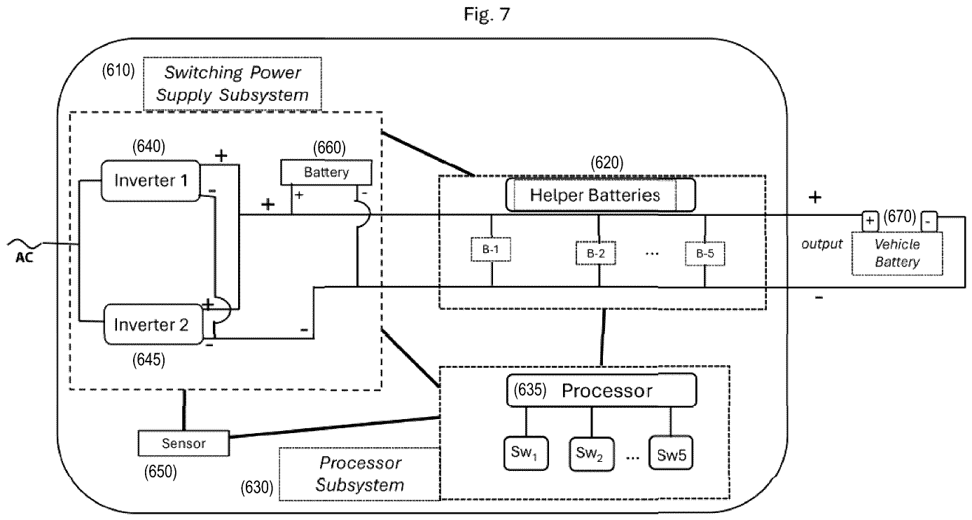

As provided in another embodiment shown in FIG. 7 (similar to the pattern shown in FIG. 1), for example, the processor (635) controls release of the electrical current from the helper batteries (620) in an ascending, sequential, timed-release pattern, so that the first helper battery (e.g., B1) is timed to release current for a specified time (e.g., 0.05 to 0.5 seconds), then helper battery 2 (i.e., B2) is timed to release current for a specified time (e.g., 0.05 to 0.5 seconds), then helper battery 3 (i.e., B3) is timed to release current for a specified time (e.g., 0.05 to 0.5 seconds), and so forth in a similar progression for other helper batteries, up to a maximum of the total number of helper batteries. Thus, released current at a specified time interval from each sequential helper battery yields progressively higher current at each step in the sequential pattern controlled by the processor. Further, as the processor controls each helper battery to first release current and then the processor causes the helper battery to cease releasing current at a specified time interval, the primary power source then provides current to the relevant helper battery as the processor terminates the current release, resulting in a relatively quickly recharged state for each helper battery (e.g., 0.01 second of recharge time). In such an embodiment, an ascending, sequential, timed-release pattern can release current from less than the total number of helper batteries, as a partially-charged target vehicle battery may not require as much current to jumpstart the battery as a fully-depleted target vehicle battery. In an embodiment, processor-controlled release of the current from the helper batteries in an ascending, sequential, timed-release pattern can be used, for example, for light duty vehicles having, for example, a battery of about 12 volts. Such lower voltage batteries can be jumpstarted using the sequentially-increasing current release to the target vehicle battery. In one or more embodiments, an example output of release of the electrical current from the helper batteries in an ascending, sequential, timed-release pattern ranges from about 100 to 500 amps.

FIG. 7 shows a further exemplary embodiment of the present disclosure. In this example of FIG. 7, there is a shorthand designation for individual helper batteries (e.g., B₁ to B₅) that can also be incorporated into a capacitor bank instead of, or in addition to, individual capacitors as described herein. In operation of this exemplary embodiment, electrical power provided by the switching power supply subsystem (610) is controlled by the processor subsystem (630), so that progressively increasing stepwise electrical current from the capacitor bank is sequentially released from the individual helper batteries (620) at a timed interval, so that (in this example) progressively increasing power is provided to jumpstart a vehicle battery ( ) 670. In this example, initial current is progressively increased at regular timed intervals as determined by the programmed processor (635) of the processor subsystem (630). Example initial current released from a first helper battery (B₁) can range from 100 to 500 amps, and final current released from B₅ can range from about 100 to 500 amps. This ascending sequential electrical current exemplary embodiment is an example of a jumpstarting power management to jumpstart a typical 12-volt automobile battery, such as (for example) a light duty passenger car, a sport utility vehicle, up to and including various larger passenger vehicles and light duty trucks. This ascending sequential electrical current exemplary embodiment can also be used with smaller battery powered vehicles such as golf carts, sport all-terrain vehicles, light duty boats and jet skis, other watercraft, and the like. The ascending sequential electrical current embodiment also provides a safety feature by progressively increasing the power output without causing excessive current to damage the target battery. While this example describes an embodiment including helper batteries B₁ to B₅, the number of helper batteries can be increased or decreased in the charge storage subsystem, for example, B₁ to B₂, B₁ to B₃, B₁ to B₄, B₁ to B₆, and the like, so that the initial and final power output from the charge storage subsystem ranges from about 100 to 1500 amps.

As provided in an embodiment illustrated in FIG. 7 (similar to the pattern shown in FIG. 2), for example, the processor (635) controls release of the electrical current from the helper batteries in a descending, sequential, timed-release pattern, so that the first helper battery (e.g., B1a) is timed to release current for a specified time (e.g., 0.05 to 0.5 seconds), then helper battery 2 (i.e., B2a) is timed to release current for a specified time (e.g., 0.05 to 0.5 seconds), then helper battery 3 (i.e., B3a) is timed to release current for a specified time (e.g., 0.05 to 0.5 seconds), and so forth in a similar progression for other helper batteries, up to a maximum of the total number of helper batteries. Thus, released current at a specified time interval from each sequential hepper battery yields progressively lower current at each step in the sequential pattern controlled by the processor (635). Further, as the processor (635) controls each helper battery to first release current and then the processor (635) causes the helper battery to cease releasing current at a specified time interval, the switching power supply subsystem (610) then provides current to the relevant helper battery as the processor (635) terminates the current release, resulting in a relatively quickly recharged state for each helper battery (e.g., 0.01 second of recharge time). In such an embodiment, a descending, sequential, timed-release pattern can release current from less than the total number of helper batteries, as a partially-charged target vehicle battery may not require as much current to jumpstart the battery as a fully-depleted target vehicle battery. In an embodiment, processor-controlled release of the current from the helper batteries in a descending, sequential, timed-release pattern can be used, for example, for heavier duty vehicles having, for example, a battery of 12 to 24 volts, or even a plurality of target vehicle batteries requiring a high power initial jumpstart current, such as in vehicles with a diesel engine. Such higher voltage batteries can be jumpstarted using the sequentially-decreasing current release to the target vehicle battery. In one or more embodiments, an example output of release of the electrical current from the helper batteries in a descending, sequential, timed-release pattern ranges from about 100 to 500 amps.

Also shown in this example of FIG. 7, there is a shorthand designation for each exemplified switch component as “Sw”, with an accompanying numeric designator for each switch. For example, Sw₁ corresponds to switch 1, Sw₂ corresponds to switch 2, and Sw₅ corresponds to switch 5. The ellipsis ( . . . ) in FIG. 7 indicates that the example of FIG. 6 can also include additional switches (e.g., Sw₃ and Sw₄), but these are not shown for convenience of the FIG. 7 size in this disclosure. Note that a greater or lesser number of switches can be used in one or more similar embodiments, depending on the specific power switching needs for jumpstarting a vehicle battery.

Further, FIG. 7 shows another exemplary embodiment of the present disclosure. In this example of FIG. 7, there is an indication of a switching power supply subsystem (610), a bank of helper batteries (620), a sensor (650), and a processor subsystem (630). These subsystems can all be contained in a single unit or container, such as a rigid plastic box or other appropriate container. Materials for such a box or container include plastics of varying densities and thicknesses, lightweight aluminum or other metal, and other synthetic materials that can be insulated or non-insulated. In one or more embodiments, the box or container can comprise a suitcase-like configuration that is portable, and can additionally have wheels for ease of portability. The container or box can be configured to weigh no more than about 75 pounds, but can also be configured to weigh 8 lbs, 10 lbs, 12 lbs, 15 lbs, 20 lbs, 25 lbs, 30 lbs, 35 lbs, 40 lbs, 45 lbs, 50 lbs, 55 lbs, 60 lbs, 65 lbs, or the like, depending upon the desired power capabilities and accompanying components in the subsystems and overall jumpstarter system as described herein. In another embodiment, the subsystems can also be configured in a permanent or temporary attachment to a base or housing, so that one or more of the subsystems can be added or removed as necessary. In another embodiment, one or more of the subsystems can be fully or partially contained within, on, or adjacent to the container for ease of portability prior to or during operation of the jumpstarter system. In another embodiment, one or more associated components can be added or removed from the system as appropriate, such as individual jumper cables, alarms, other sensors and electrical interconnections for operation of the jumpstarter system. In the embodiment exemplified in FIG. 7, the components and subsystems are shown in one example arrangement, but other configurations of the individual components and subsystems and their electrical interconnections can be varied without detracting from the system's capabilities.

The jumpstarter system can comprise one or more processors (e.g., a microprocessor, a central processing unit (CPU), and the like) to control the various operations of the jumpstarter system. Such operations include, for example, to monitor and/or selectively charge or boost external devices. The one or more processors can be operatively coupled to one or more memory devices, such as a read-only memory (ROM) for receiving one or more instruction sets, a random access memory (RAM) having a plurality of buffers for temporarily storing and retrieving information, and to an internal data storage device (e.g., a hard drive, such as a solid state drive, or other non-volatile data storage device, such as flash memory, and the like). An electric or mechanical clock is also coupled to the processor for providing clock or timing signals or pulses thereto. One of ordinary skill in the art will readily understand that the jumpstarter system also can include one or more bus structures for interconnecting its various components. One or more of the processor components are included within the term “processor subsystem”.

The jumpstarter system can be removably coupled with a vehicle or the battery (e.g., at its battery posts/terminals) of the vehicle via a pair of electrical conductors (e.g., positive and negative electrical conductors), which can be electrically coupled with the jumpstarter system. Each of the electrical conductors can comprise, for example, a battery cable having one or more terminal connector(s) at its distal end. For example, the terminal connectors can be a set of battery clamps (i.e., a positive clamp and a negative clamp), a set of ring connectors, a plug (e.g., a quick connect plug), and the like.

In one or more embodiments, a power source comprises incoming alternating current (also referred to as “AC”) and an electrically interconnected inverter. In one example of operating the jumpstarter system, the switching power supply subsystem electrical current is sensed by one or more electrically connected sensors, wherein the sensor is also electrically interconnected to the processor in the jumpstarter system. At least one internal battery (also referred to as a secondary power source) is also electrically connected in parallel to the power source. The processor and sensor are simultaneously electrically connected to the at least one internal battery, so that the processor subsystem determines the amount of incoming electrical current along with measuring the internal battery charge status. The switching power supply subsystem also is electrically connected to a plurality of capacitors at the output of the power source. Similarly, the output of the secondary power source is electrically connected to the plurality of capacitors. The plurality of capacitors are further electrically interconnected in parallel circuitry. The processor is further electrically interconnected to the plurality of capacitors, so that the processor directs the flow of electrical current from the incoming power source, while also controlling the amount of additional electrical current flow (if any) from a secondary power source. The processor is further configured to sequentially trigger the capacitors to release appropriate amount of power for a period of time to provide a jumpstart to a connected vehicle battery, depending on the specific power needs and operation of the jumpstarter system.

In an embodiment, the processor is configured to release current from the charged capacitors in a sequential, timed-release pattern, to facilitate jumpstarting of a target vehicle battery. Processor control of current release from the disclosed jumpstarter system facilitates repeated jumpstarting current that can be provided to the target vehicle battery (or group of target vehicles and associated batteries). Generally, the amount of amps needed to jumpstart a vehicle depends on the size of the vehicle engine. For example, most passenger vehicles and light duty trucks require a range of about 400 to 660 cold cranking amps (CCA) to start the vehicle. In one or more embodiments, electrical output of the jumpstarter system can range from about 300 to 3500 amps. In an embodiment, the processor-controlled switching does not necessarily require a high-amp starting point for a jumpstarter.

As provided in an embodiment shown in FIG. 1, for example, the processor controls release of the electrical current from the capacitors in an ascending, sequential, timed-release pattern, so that the first capacitor (e.g., C1) is timed to release current for a specified time (e.g., 0.05 to 0.5 seconds), then capacitor 2 (i.e., C2) is timed to release current for a specified time (e.g., 0.05 to 0.5 seconds), then capacitor 3 (i.e., C3) is timed to release current for a specified time (e.g., 0.05 to 0.5 seconds), and so forth in a similar progression for other capacitors, up to a maximum of the total number of capacitors. Thus, released current at a specified time interval from each sequential capacitor yields progressively higher current at each step in the sequential pattern controlled by the processor. Further, as the processor controls each capacitor to first release current and then the processor causes the capacitor to cease releasing current at a specified time interval, the primary power source then provides current to the relevant capacitor as the processor terminates the current release, resulting in a relatively quickly recharged state for each capacitor (e.g., 0.01 second of recharge time). In an example embodiment shown in FIG. 4, each Resistor (R) moderates the time period to recharge the respective capacitor. For example, R1 moderates the required time for capacitor C1 to be recharged, R2 moderates the required time for capacitor C2 to be recharged, R3 moderates the required time for capacitor C3 to be recharged, and R4 moderates the required time for capacitor C4 to be recharged. In such an embodiment, an ascending, sequential, timed-release pattern can release current from less than the total number of capacitors, as a partially-charged target vehicle battery may not require as much current to jumpstart the battery as a fully-depleted target vehicle battery. In an embodiment, processor-controlled release of the current from the capacitors in an ascending, sequential, timed-release pattern can be used, for example, for light duty vehicles having, for example, a battery of about 12 volts. Such lower voltage batteries can be jumpstarted using the sequentially-increasing current release to the target vehicle battery. In one or more embodiments, an example output of release of the electrical current from the capacitors in an ascending, sequential, timed-release pattern ranges from about 100 to 500 amps. In one or more embodiments, the minimum storage capacity of each capacitor (C) is about 3000 μF. In another embodiment, each capacitor (C) has a capacitance of at least 4000 μF. In still another embodiment, each capacitor (C) has a capacitance of at least 5000 μF. In yet another embodiment, each capacitor (C) has a capacitance of at least 6000 μF. In a further embodiment, each capacitor (C) has a capacitance of at least 7000 μF.

As provided in one or more embodiments according to FIGS. 6a, 6b, 6c and 7, for example, the processor controls release of the electrical current from the capacitors (or helper batteries in a descending, sequential, timed-release pattern, so that the first capacitor (e.g., C1a) is timed to release current for a specified time (e.g., 0.05 to 0.5 seconds), then capacitor 2 (i.e., Ca) is timed to release current for a specified time (e.g., 0.05 to 0.5 seconds), then capacitor 3 (i.e., C3a) is timed to release current for a specified time (e.g., 0.05 to 0.5 seconds), and so forth in a similar progression for other capacitors, up to a maximum of the total number of capacitors. Thus, released current at a specified time interval from each sequential capacitor yields progressively lower current at each step in the sequential pattern for a specified period of time controlled by the processor. Further, as the processor controls each capacitor to first release current and then the processor causes the capacitor to cease releasing current at a specified time interval, the primary power source then provides current to the relevant capacitor as the processor terminates the current release, resulting in a relatively quickly recharged state for each capacitor (e.g., 0.01 second of recharge time). In such an embodiment, a descending, sequential, timed-release pattern can release current from less than the total number of capacitors, as a partially-charged target vehicle battery may not require as much current to jumpstart the battery as a fully depleted target vehicle battery. In an embodiment, processor-controlled release of the current from the capacitors in a descending, sequential, timed-release pattern can be used, for example, for heavier duty vehicles having, for example, a battery of 12 to 24 volts, or even a plurality of target vehicle batteries requiring a high power initial jumpstart current, such as in vehicles with a diesel engine. Such higher voltage batteries can be jumpstarted using the sequentially-decreasing current release to the target vehicle battery. In one or more embodiments, an example output of release of the electrical current from the capacitors in a descending, sequential, timed-release pattern ranges from about 100 to 500 amps.

In an embodiment, the jumpstarter system can be operated at an initial high amperage to jumpstart a target vehicle battery. The sequential capacitors, having an initial high-charge capacity, and their associated charge status, allow the jumpstarter to continue to repeatedly provide high amperage output without sacrificing performance of the jumpstarter system. Accordingly, the jumpstarter system can provide high amperage output for an extended period of time until the vehicle engine engages to a regular operating state, so even the most charge-depleted target vehicle battery can be jumpstarted. Further, the capacitors (or helper batteries) that are connected in parallel circuitry provide reliability and repeatability in providing such extended high amperage output without damaging the jumpstarter system or its capabilities.

In an embodiment, the jumpstarter system can include a Bluetooth speaker electrically interconnected with the processor. In another embodiment, the jumpstarter system can include one or more alarms electrically interconnected with the processor and one or more associated sensors, wherein the processor is configured to output an alarm signal if a specific event is triggered while operating the jumpstarter system. For example, where a target vehicle battery is inadvertently disconnected during a jumpstart activity, the alarm can signal the user to terminate the operation of the jumpstarter system, in order to correct the disconnected battery. In a further embodiment, the jumpstarter system can include a remote control interface electrically interconnected with the processor. In an embodiment, a remote control output signal can also be used to communicate with a cellular phone or other mobile device. In yet another embodiment, the jumpstarter system can include a 110 volt outlet that can be used, for example, to provide electrical current for a device to be plugged into the outlet.

The following description provides an example jumpstarter embodiment; however, one or more of the described features, whether alone or in combination, can also apply to one or more additional embodiments. Further, where specific components are recited, one of skill in the art understands that one can substitute one or more similar components, as appropriate, without deviating from the spirit of the invention.

In an embodiment, a pair of charging cables are electrically interconnected with the electrical output of the jumpstarter system. A user attaches the positive and negative charging cables to a target battery, such as a 12 volt battery in a vehicle, so that sufficient electrical current can be provided from the jumpstarter system to temporarily recharge the target battery and start the vehicle engine. The charging cables can also be referred to as jumper cables, or booster cables. A positive (+) charging cable is often color-coded red, and a negative (−) jumper cable is often color-coded black. However, color variations can occur, and the color-coding for safety or identification purposes are also considered part of this invention. The charging cables can be of various gauge (size), typically ranging from 1 to 4 gauge. In an embodiment, the charging cables of the present system are 2 gauge or 4 gauge in size. The input wire gauge is about 12 AWG, but can vary from 8 to 14 AWG.

In another embodiment, a user attaches the charging cable leads to a target vehicle battery. If the target battery has a residual amount of charge, then an optional integrated sensor in the jumpstarter system detects the corresponding electrical charge remaining in the vehicle battery, and the integrated red signal light of the jumpstarter system produces a red light output to visually inform the user that a jumpstart event can be attempted by the user pushing the system start button. While a red signal light is described, other colors can be used for convenience and/or user preference. Once pressed (engaged) by the user, the system start button causes DC current to flow from the inverter and eventually through the charging cables to the connected target vehicle battery, providing a temporary recharge to the battery to start the vehicle engine.

In another embodiment, a user attaches the charging cable leads to a target vehicle battery. If the target battery has been completely depleted (i.e., no electrical charge), then an integrated sensor in the jumpstarter system does not detect even a minor electrical charge. In this embodiment, the integrated red signal light of the jumpstarter system does not produce any red light output, so the user then is informed that high electrical current is necessary to provide a sufficient temporary recharge to the depleted battery. Again, a red-colored signal light is described, but other signal light/bulb colors can be employed in one or more embodiments.

In an embodiment, the internal rechargeable battery of the jumpstarter system can be charged via an interfaced power cord from an external standard 110 or 220 volt outlet. In an embodiment, a generator can also provide sufficient voltage input for recharging the battery. An external generator power source can also be used in concert with the switching power supply subsystem of the jumpstarter system.

In an embodiment, if the target vehicle battery is completely dead, then one needs to manually engage (press) the manual start button (e.g., a small red button on the user keypad/interface). Upon pressing the manual start button, there can be a clicking sound, indicating current is flowing from the inverter to the output for jumpstarting the target vehicle battery. In an embodiment, pressing the manual start button can trigger a response light to visually indicate engagement of the start, and/or an audible sound such as a clicking sound to provide both visual and audible indication of engagement of the manual start button. In an embodiment, the manual start can be a tactile keypad button, or a raised button, and/or a selectable prompt of a mobile app on a user's smartphone. Any combination of one or more of these manual start button configurations can also be employed. In another embodiment, one or more indicator lights/buttons on the jumpstarter system are electrically interconnected with one or more sensors and/or electrically interconnected with a processor subsystem of the jumpstarter system, where such sensor(s) can interact with the processor subsystem to provide an indication of target vehicle battery status (such as charged, partially charged, or absence of charge).

In an embodiment, the jumpstarter system can have a multi-function mode for operating the internal battery, and also for enabling one or more of the accessory features. For example, in an embodiment, a user engages (pushes) a separately labelled button such as a green button, to determine the status of the internal battery. Alternatively, or additionally, a user can engage the multi-function mode to turn on the flashlight, or to activate the strobe light, or to activate any other feature of the starter subsystem, depending on the configuration and the included components and associated features thereof.

In an embodiment, a user can engage the manual start button when the internal sensor does not detect a presence of a target connected vehicle battery interfaced with the charging cables from the jumpstarter system, such as when the target vehicle battery is depleted and there is not even a residual charge in the target battery. By engaging the manual start button, the user causes current to flow to the target vehicle battery through the connected charging cables.

If the target vehicle is relatively small and does not require maximum power to jumpstart, then the internal battery of the jumpstarter system provides sufficient electrical output to jumpstart the vehicle. However, if the target vehicle battery does not receive sufficient current from the internal jumpstarter system battery, then the user interfaces the jumpstarter system with an external alternating current source by plugging the jumpstarter AC cable into an outlet, such as a standard 110 to 220 volt wall outlet, or even into a generator that outputs sufficient alternating current. The user disengages the internal battery current flow, since higher current is required to jumpstart the target vehicle battery. If using a generator, then typically a generator of 2500 watts is a minimum level needed to provide the AC power input to the jumpstarter system.

In an embodiment of a 2 inverter jumpstarter system, the switching power supply subsystem directs each of the 2 inverters (i.e., the first and second inverters) to initially provide a max output of 200 amps (i.e., a total of 400 amps max output) for no more than about 5 seconds. However, in order to avoid overheating, at about the 5 second point, the processor subsystem then directs the integrated capacitors of the first and second inverters to output a maximum of about 160 amps, yielding a consistent output of about 320 amps for up to about 30 seconds to jumpstart the target vehicle battery. Accordingly, at the beginning, the jumpstarter system provides an output of about 200 amps from each inverter (total of 400 amps), but only for about 5 seconds. Then, after this initial 5 second period of max power, the amp output is reduced because the starter system is using the capacitors for the power output to the target vehicle battery.

In one or more embodiments, the switching power supply subsystem with 1 or more inverter(s) is configured so that it does not shut down due to excess heat or power demand when operating at about 80% of the sustained power capacity. The jumpstarter system does not shut down when there is an initial high amperage immediately, unless the system exceeds that 80% level for more than about 5 seconds and when the system becomes hot, it has 2 integrated cooling fans to supply a cooling airstream and/or heat dissipation in the carrying case/housing.

In an embodiment, all cables can be stored within the housing, facilitating efficiency and portability of the jumpstarter system. Further, the AC power cord can also be retractable into the housing. Also, an optional air pump/inflator can also be contained within the jumpstarter system housing, in the event that a user also desires to provide air to fill one or more vehicle tires. As understood by one of ordinary skill, one or more other accessory components can also be integrated into the housing, such as, for example, a secondary light source including a flashlight, one or more analog/digital gauges or monitors, and the like.

In an embodiment, the jumpstarter system housing is constructed of lightweight but strong material(s), such as weatherproof material(s), and is fabricated of an outer waterproof material such as HDPE plastic, fiberglass, or similar material. The housing can also incorporate a waterproof inner seal around the internal periphery so that the housing is completely resistant to any water or inclement weather conditions, including dusty environments. The waterproof internal seal also protects against infiltration of dust, sand, or even smoke. The housing can also incorporate an integrated handle that is fixed or retractable, and the housing further can include one or more connectors for fastening to a second jumpstarter system housing for ease of transport.

In an embodiment, the jumpstarter system weighs about 8 to 20 pounds, though the weight can vary as the number of incorporated inverters increases. Adding further internal optional components can also add further weight to the jumpstarter system, depending upon the user's preferred configuration. For example, a 1-inverter jumpstarter system as described herein can weigh about 8 to 15 pounds, and is easily transportable in a single unit housing. In another example, a 2-inverter jumpstarter system as described herein can weigh about 15 to 20 pounds, and is also easily transportable in a single unit housing. A second 2-inverter jumpstarter system can be releasably connected to a first jumpstarter system, for ease of portability of both systems simultaneously. In an embodiment, the jumpstarter system (e.g., a 1-inverter or 2-inverter system) can also have a housing with incorporated and/or removable wheels, similar in size and weight to a piece of carryon luggage. The incorporated or removable wheels can facilitate long distance moving of the system, though the integrated handle also is sufficient to allow a user to transport the jumpstarter system as a single unit, or even a double unit if connected to a second jumpstarter system.

In an embodiment, the jumpstarter system can also be wall-mounted, such as for placement in close proximity to a car servicing bay in an auto service shop. For example, where multiple vehicle service bays are involved, a user can fixedly or removably mount a jumpstarter system at or near each service bay to facilitate ease of use by a servicing technician without requiring long lengths of live copper wire from a single jumpstarter system unit to multiple service bays or servicing platforms. In an embodiment, the wall-mounted jumpstarter system can also include removable components for further customization by a user.

In an embodiment, a first and second jumpstarter system can be attached as a single unit for ease of portability of both systems. However, in operation, the first jumpstarter and second jumpstarter may not use a single power source, i.e., a separate alternating current circuit would be appropriate for each unit, so each system would be plugged into separate AC power sources with separate breakers. Alternating current power sources can be 110 or 220 volts, depending on the user's needs and preferences for powering the jumpstarter systems.

Thus, exemplary embodiments and related descriptions of a multi-powered vehicle battery jumpstarter system and methods of using such a system have been disclosed. It should be apparent, however, to those skilled in the art, that many more modifications besides those already described are possible without departing from the inventive concepts herein. Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced.

1. A battery jumpstarter system comprising:
(a) a switching power supply subsystem comprising:
(1) an inverter electrically interconnected in parallel circuitry with a capacitor bank; and
(2) a battery;
wherein said inverter and said battery are electrically interconnected in parallel circuitry with an alternating current input source,
(b) a processor subsystem comprising at least one processor electrically interconnected in parallel circuitry with said switching power supply subsystem, wherein said processor subsystem includes a timer function and is configured to control operation of said capacitor bank; and
(c) at least one sensor, wherein said at least one sensor is electrically interconnected in parallel circuitry with said switching power supply subsystem and said processor subsystem.

2. The jumpstarter system of claim 1, wherein said capacitor bank is configured to provide electrical current output selected from:
(a) ascending sequential electrical current;
(b) descending sequential electrical current; or
(c) equal sequential electrical current.

3. The jumpstarter system of claim 1, wherein said switching power supply subsystem, said processor subsystem, said capacitor bank, and said at least one sensor are combined in a single housing.

4. The jumpstarter system of claim 1, wherein said switching power supply subsystem, said processor subsystem, said capacitor bank, and said at least one sensor are removably attached within a single housing.

5. The jumpstarter system of claim 1, wherein said battery comprises a rechargeable battery.

6. The jumpstarter system of claim 5, wherein said battery comprises a Lithium-ion battery.

7. The jumpstarter system of claim 1, wherein said jumpstarter system is configured to provide an initial electrical output of about 400 amps for about 5 seconds, and a subsequent sustained output of about 360 amps for about 30 seconds.

8. A battery jumpstarter system comprising:
(a) a switching power supply subsystem comprising:
(1) a first inverter electrically interconnected in parallel circuitry with a first capacitor bank;
(2) a second inverter electrically interconnected in parallel circuitry with a second capacitor bank; and
(3) a battery;
wherein said first inverter, said second inverter, and said battery are electrically interconnected in parallel circuitry with an alternating current input source,
(b) a processor subsystem comprising at least one processor electrically interconnected in parallel circuitry with said switching power supply subsystem, wherein said processor subsystem includes a timer function and is configured to control operation of said first capacitor bank and said second capacitor bank; and
(c) at least one sensor, wherein said at least one sensor is electrically interconnected in parallel circuitry with said switching power supply subsystem and said processor subsystem.

9. The jumpstarter system of claim 8, further comprising a pair of charging cables to interface with a vehicle battery.

10. The jumpstarter system of claim 8, wherein said at least one sensor is operatively configured to provide charge status of a vehicle battery.

11. The jumpstarter system of claim 8, wherein said first capacitor bank and said second capacitor bank are configured to provide electrical current output selected from:
(a) ascending sequential electrical current;
(b) descending sequential electrical current; or
(c) equal sequential electrical current.

12. The jumpstarter system of claim 8, wherein said switching power supply subsystem, said processor subsystem, said first and second capacitor banks, and said at least one sensor are removably attached within a single housing.

13. The jumpstarter system of claim 8, wherein said battery comprises a rechargeable battery.

14. The jumpstarter system of claim 8, wherein said jumpstarter system is configured to provide an initial electrical output of about 400 amps for about 5 seconds, and a subsequent sustained output of about 360 amps for about 30 seconds.

15. A battery jumpstarter system comprising:
(a) a switching power supply subsystem comprising:
(1) a first inverter electrically interconnected in parallel circuitry with a first capacitor bank;
(2) a second inverter electrically interconnected in parallel circuitry with a second capacitor bank;
(3) a third inverter electrically interconnected in parallel circuitry with a third capacitor bank; and
(4) a battery;
wherein said first inverter, said second inverter, said third inverter, and said battery are electrically interconnected in parallel circuitry with an alternating current input source,
(b) a processor subsystem comprising at least one processor electrically interconnected in parallel circuitry with said switching power supply subsystem, wherein said processor subsystem includes a timer function and is configured to control operation of said first capacitor bank, said second capacitor bank, and said third capacitor bank; and
(c) at least one sensor, wherein said at least one sensor is electrically interconnected in parallel circuitry with said switching power supply subsystem and said processor subsystem.

16. The jumpstarter system of claim 15, further comprising a pair of charging cables to interface with a vehicle battery.

17. The jumpstarter system of claim 15, wherein said first capacitor bank, said second capacitor bank, and said third capacitor bank are configured to provide electrical current output selected from:
(a) ascending sequential electrical current;
(b) descending sequential electrical current; or
(c) equal sequential electrical current.

18. The jumpstarter system of claim 15, wherein said switching power supply subsystem, said processor subsystem, said first, second, and third capacitor banks, and said at least one sensor are removably attached within a single housing.

19. The jumpstarter system of claim 15, wherein said battery comprises a rechargeable battery.

20. The jumpstarter system of claim 15, wherein said jumpstarter system is configured to provide an initial electrical output of about 600 amps for about 5 seconds, and a subsequent sustained output of about 540 amps for about 30 seconds.
